(19) United States
(12) Patent Application Publication
(10) Pub. No.: US 2024/0103934 A1
(43) Pub. Date: Mar. 28, 2024

(54) ALLOCATION CONTROL APPARATUS, COMPUTER SYSTEM, AND ALLOCATION CONTROL METHOD

(71) Applicant: Hitachi, Ltd., Tokyo (JP)

(72) Inventors: Shimpei NOMURA, Tokyo (JP); Mitsuo HAYASAKA, Tokyo (JP)

(73) Assignee: Hitachi, Ltd., Tokyo (JP)

(21) Appl. No.: 18/181,732

(22) Filed: Mar. 10, 2023

(30) Foreign Application Priority Data
Sep. 28, 2022 (JP) 2022-154916

(51) Int. Cl. G06F 9/50

(52) U.S. Cl. CPC G06F 9/5094

(57) ABSTRACT

A memory of an application platform stores per site a performance model indicating a relationship between program performance and a resource amount of hardware necessary for realizing program performance, and an electric power consumption model indicating a relationship between a resource allocation amount that is an amount allocated to the program, and an electric power consumption amount consumed when the program is executed. The CPU receives target performance information that indicates target performance for the program, calculates per site a necessary allocation amount and a necessary electric power consumption amount that are a resource allocation amount and an electric power consumption amount necessary for realizing the target performance by using the target performance information, the performance model, and the electric power consumption model, and creates a container/data allocation plan that is an allocation plan of an execution platform of the program and data based on a result of the calculation.

### BACKGROUND OF THE INVENTION

### 1. Field of the Invention

The present disclosure relates to an allocation control apparatus, a computer system, and an allocation control method.

### 2. Description of the Related Art

A technique of analyzing data stored in a storage by Artificial Intelligence (AI), an application program (abbreviated as an application below) such as data analysis software, or the like, and using an analysis result of the data for various services is gaining attention. A technique of this type uses a computer system including a plurality of sites such as a hybrid cloud environment across an on-premises data center and a public cloud as a platform for executing data analysis. According to data analysis that uses a computer system including a plurality of sites, data and applications are allocated at appropriate sites taking indices such as a cost and target performance (such as an execution time) required for data analysis into account, and then data analysis is executed.

JP 2022-045666 A discloses a technique of controlling a HardWare (HW) resource amount that is a hardware resource amount allocated to software executed on a computer node according to target performance designated by a user. By using this technique, it is possible to allocate the data and the application at a site that satisfies the target performance.

### SUMMARY OF THE INVENTION

In recent years, improvement or conservation of global environment has been regarded as important, and therefore utilization of renewable energy has been demanded. According to data analysis that uses a computer system including a plurality of sites, it is thought that, by, for example, allocating data and applications so as to increase use efficiency of renewable energy, it is possible to efficiently utilize the renewable energy. However, the technique described in JP 2022-045666 A does not describe a electric power consumption amount consumed by computer nodes at each site when data analysis is performed, and cannot efficiently utilize renewable energy.

An object of the present disclosure is to provide an allocation control apparatus, a computer system, and an allocation control method that can execute desired processing at an appropriate site that takes an electric power consumption amount into account.

An allocation control apparatus according to one aspect of the present disclosure is an allocation control apparatus that creates an allocation plan for selecting one of a plurality of sites as an allocation site, the plurality of sites each storing data and including a computer node capable of constructing an execution platform that executes a program for performing processing related to the data, and the allocation site including the execution platform and the data allocated therein, and comprises: a memory; and a processor, and the memory stores a performance model and an electric power consumption model per site, the performance model indicating a relationship between performance of the program and a resource amount of hardware necessary for realizing the performance of the program, and the electric power consumption model indicating a relationship between a resource allocation amount that is the resource amount allocated to the program, and an electric power consumption amount consumed when the program is executed, and the processor further receives target performance information indicating target performance for the program, calculates a necessary allocation amount and a necessary electric power consumption amount per site by using the target performance information, the performance model, and the electric power consumption model, and creates the allocation plan based on a result of the calculation, the necessary allocation amount and the necessary electric power consumption amount being the resource allocation amount and the electric power consumption amount necessary for realizing the target performance.

According to the present invention, it is possible to execute desired processing at an appropriate site that takes an electric power consumption amount into account.

### BRIEF DESCRIPTION OF THE DRAWINGS

FIG. 1 is a diagram illustrating an entire configuration of a computer system according to an embodiment of the present disclosure;

FIG. 2 is a diagram illustrating an example of a hardware configuration of a site;

FIG. 3 is a diagram illustrating an example of a metadata DB;

FIG. 4 is a diagram illustrating an example of a resource management table;

FIG. 5 is a diagram illustrating an example of electric power prediction information;

FIG. 6 is a diagram illustrating an example of an inter-site network management table;

FIG. 7 is a diagram illustrating an example of an app management table;

FIG. 8 is a diagram illustrating an example of an app performance model management table;

FIG. 9 is a diagram illustrating an example of an app performance model;

FIG. 10 is a diagram illustrating an example of a data store management table;

FIG. 11 is a diagram illustrating an example of a data store performance model management table;

FIG. 12 is a diagram illustrating an example of a data store performance model;

FIG. 13 is a diagram illustrating an example of an electric power consumption model management table;

FIG. 14 is a diagram illustrating an example of an electric power consumption model;

FIG. 15 is a flowchart for describing an example of data store performance model creation processing;

FIG. 16 is a flowchart for describing an example of app performance model creation processing;

FIG. 17 is a flowchart for describing an example of electric power consumption model creation processing;

FIG. 18 is a flowchart for describing an example of inter-distributed site metadata search processing;

FIG. 19 is a diagram for describing an example of intra-site metadata search processing that is processing on a side that has received a search query;

FIG. 20 is a diagram for describing an example of an inter-distributed site metadata search result;

FIG. 21 is a flowchart for describing an example of app deployment processing;

FIG. 22 is a diagram illustrating an example of a container/data allocation plan calculation request screen;

FIG. 23 is a flowchart for describing an example of allocation plan creation processing;

FIG. 24 is a diagram for describing an example of processing of calculating a resource allocation amount of an app and the like;

FIG. 25 is a diagram for describing an example of processing of calculating a resource allocation amount of a data store and the like; and

FIG. 26 is a diagram illustrating an example of a container/data allocation plan.

### DETAILED DESCRIPTION

An embodiment of the present disclosure will be described below with reference to the drawings. Note that the embodiment described below does not limit the disclosure according to the claims, and all of the components described in the embodiment and combinations thereof are not necessarily essential to the solution of the present disclosure.

Note that, although the following description will describe processing using a “program” as a subject in some cases, when the program is executed by a processor (e.g., a Central Processing Unit (CPU)), predetermined processing is performed appropriately using a storage resource (e.g., a memory) and/or a communication interface device (e.g., Network Interface Card (NIC)), and therefore may be processing where the subject of the processing is the processor or a calculator including the processor.

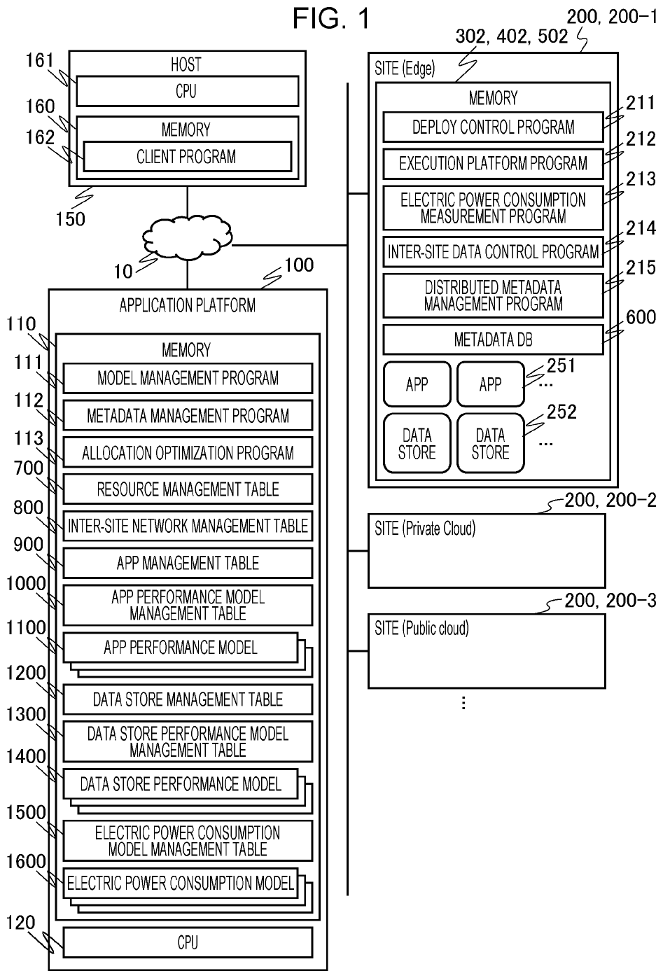

FIG. 1 is a diagram illustrating an entire configuration of a computer system according to the embodiment of the present disclosure. The computer system illustrated in FIG. 1 includes an application platform 100, a host 150, and a plurality of sites 200. The application platform 100, the host 150, and each site 200 are communicably connected to each other via a network 10.

The application platform 100 is an allocation control apparatus that controls allocation of data and an execution platform that executes a program that performs predetermined processing related to the data. The execution platform is a container in the present embodiment, yet may be a Virtual Machine (VM), a process, or the like. In the present embodiment, the program that performs predetermined processing includes a first program and a second program, the first program is a data store program (abbreviated as a data store below) that manages data, and the second program is an application program (abbreviated as an application below) that accesses the data store and executes predetermined processing. However, the first and second programs are not limited to this example, and the first and second programs may be applications that perform respectively different processing. For example, the first program may be an application that performs inference of machine learning, and the second program may be an application that recommends a product, a service, or the like using an inference result of the first program.

The host 150 is used by a user who uses the computer system. The host 150 includes a memory 160 and a Central Processing Unit (CPU) 161. The memory 160 stores a client program 162. The CPU 161 reads the client program 162 stored in the memory 160, executes this read client program 162, and performs client processing. The client processing includes, for example, processing of transmitting a calculation request of a container/data allocation plan that is an allocation plan of a program execution platform and data, and a deployment request that is based on the container/data allocation plan to the application platform 100.

The site 200 is a site for storing data, and constructing a container and executing processing related to the data. Each site 200 is installed at, for example, a geographically distant place. Furthermore, each site 200 may be installed across countries. Although FIG. 1 illustrates three sites 200-1 to 200-3 as the sites 200, there may be the plurality of sites 200. Note that, although the site 200-1 is an edge, the site 200-2 is a private cloud, and the site 200-3 is a public cloud, this is merely an example, and a type of each site 200 is not limited to this example.

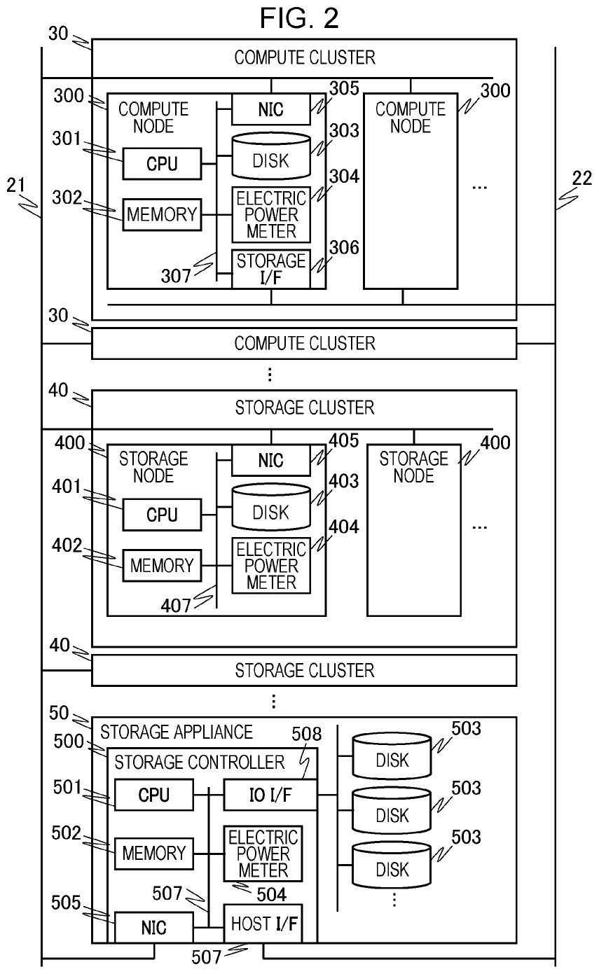

FIG. 2 is a diagram illustrating an example of a hardware configuration of each site 200. As illustrated in FIG. 2, as infrastructures that are facilities (infrastructures) for storing data and executing predetermined processing, the site 200 includes one or more compute clusters 30, one or more storage clusters 40, and one or more storage appliances 50. The compute clusters 30, the storage clusters 40, and the storage appliances 50 are communicably connected to each other via an LAN 21 and an SAN 22. Note that the infrastructure is a node group including one or more computer nodes.

The compute cluster 30 is a set of compute nodes 300, and includes the one or more compute nodes 300. In the present embodiment, the compute cluster 30 includes the compute nodes 300 of equal electric power efficiency. Furthermore, the compute cluster 30 may be configured for convenience of a user.

The compute node 300 is a computer node that executes an application, and performs predetermined processing. In the present embodiment, the compute node 300 is realized by a general-purpose computer system, yet may be realized by dedicated equipment. The compute node 300 includes a CPU 301, a memory 302, a disk 303, an electric power meter 304, a Network Interface Card (NIC) 305, and a storage I/F 306 that are communicably connected to each other via a bus 307. The CPU 301 reads a program recorded in the memory 302, executes this read program, and performs various processing. The memory 302 stores a program that defines an operation of the CPU 301, and various pieces of information used or generated by the program. The disk 303 is a secondary storage device. The electric power meter 304 measures a consumption electric power amount of an own node. The NIC 305 is an interface for communicating with other apparatuses via the LAN 21. The storage I/F 306 is an interface for communicating with the storage appliance 50 via the SAN 22.

The storage cluster 40 is a set of storage nodes 400, and includes the one or more storage nodes 400. In the present embodiment, the storage cluster 40 includes the storage nodes 400 of equal electric power efficiency. Furthermore, the storage cluster 40 may be configured for convenience of the user.

The storage node 400 is a computer node that executes a data store program (abbreviated as a data store below), and manages data. In the present embodiment, the storage node 400 is realized by a general-purpose computer system, may be realized by dedicated equipment. The storage node 400 includes a CPU 401, a memory 402, a disk 403, an electric power meter 404, and an NIC 405 that are communicably connected to each other via a bus 407. The CPU 401 reads a program recorded in the memory 402, executes this read program, and performs various processing. The memory 402 stores a program that defines an operation of the CPU 401, and various pieces of information used or generated by the program. The disk 403 is a secondary storage device. The electric power meter 404 measures a consumption electric power amount of an own node. The NIC 405 is an interface for communicating with other apparatuses via the LAN 21.

The storage appliance 50 is a computer node (storage apparatus) that includes a plurality of disks 503 that store data, and a storage controller 500 that reads and writes data from and to the disks 503. The storage appliance 50 may be a block storage, may be a file storage, may be an object storage, or may be a combination thereof. The storage controller 500 includes a CPU 501, a memory 502, an electric power meter 504, an NIC 505, a host I/F 506, and an IO I/F 508 that are communicably connected to each other via a bus 507. The CPU 501 reads a program stored in the memory 502, executes this read program, and performs various processing. The memory 502 stores a program that defines an operation of the CPU 501, and various pieces of information used or generated by the program. The electric power meter 504 measures a consumption electric power amount of an own node. The NIC 505 is an interface for communicating with other apparatuses via the LAN 21. The host I/F 506 is an interface for communicating with the compute cluster 30 via the SAN 22. The IO I/F 508 is an interface for communicating with the disks 503.

As illustrated in FIG. 1, the memories 302, 402, and 502 of the compute node 300, the storage node 400, and the storage appliance 50 store a deployment control program 211, an execution platform program 212, and an electric power consumption measurement program 213. Furthermore, the memory of the compute node 300 further stores a plurality of apps (applications) 251 in addition to these programs (211 to 213), the memories 402 and 502 of the storage node 400 and the storage appliance 50 store an inter-site data control program 214 and a distributed metadata management program 215 in addition to these programs (211 to 213), and the memory 502 further stores a plurality of data stores 252. One of memories of each site stores a metadata DB 600 per site. Note that FIG. 1 illustrates each program and information without distinguishing the memories 302, 402, and 502.

The deployment control program 211 deploys the app 251 and the data store 252 on the execution platform according to the deployment request that is based on the container/data allocation plan. The execution platform program 212 constructs the execution platform (such as a container or a VM) of the app 251 and the data store 252 according to the deployment request. Furthermore, the execution platform program 212 allocates hardware resources (HW resources) to the app 251 and the data store 252 according to the deployment request, obtains hardware metrics and execution logs, and the like.

The electric power consumption measurement program 213 measures an electric power consumption amount of an own node using the electric power meter 304, 404, or 504. The inter-site data control program 214 migrates data between the sites 200 according to a data migration request that is based on the container/data allocation plan. The distributed metadata management program 215 provides an inter-site search function of a metadata DB to search for data between sites.

The metadata DB 600 is a set of metadata related to data stored in the disks 503 of the storage appliance 50.

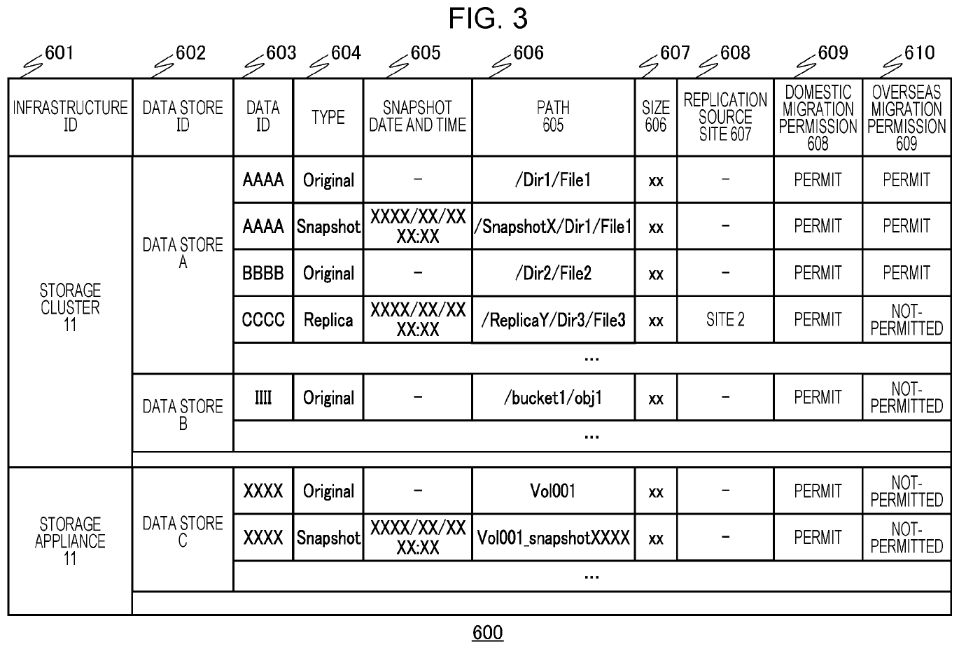

FIG. 3 is a diagram illustrating an example of the metadata DB 600. Note that, in the present embodiment, the metadata DB 600 is stored in each site 200 as described above, yet is not limited to this example, and may be stored per infrastructure, for example. Furthermore, FIG. 3 illustrates an example of the metadata DB 600 in the site 200-1.

The metadata DB 600 illustrated in FIG. 3 includes fields 601 to 610. The field 601 stores infrastructure IDs that are identification information for identifying infrastructures. In this regard, the infrastructures are the storage clusters 40 and the storage appliance 50. The field 602 stores data store IDs that are identification information for identifying data stores that manage data. The field 603 stores data IDs that are identification information for identifying data. The field 604 stores data types. In the present embodiment, the data types are “Original” that indicates original data, “Snapshot” that indicates a snapshot of the original data in the same site, or “Replica” that indicates replicated data that is a snapshot of the original data of other sites. In a case where the data type is “Snapshot” or “Replica”, the field 605 stores a snapshot date and time that is a date and time when the snapshot is obtained.

The field 606 stores path information that is storage destination information indicating storage destinations in which data is stored. However, the storage destination information is not limited to the path information, and may be different according to a storage destination type. For example, the storage destination information may be an identifier of a volume in a case where the storage destination is a block storage, a Uniform Resource Identifier (URI) in a case where the storage destination is an object storage, or the like. Furthermore, the storage destination may be a Uniform Resource Locator (URL) of a database, a table name, or the like. The field 607 stores data sizes. The field 608 stores site IDs that are identification information for identifying sites of replication sources of the data (replicated data) in a case where the data type is “Replica”. The fields 609 and 610 store restriction information related to data migration. More specifically, the field 609 stores domestic migration permission information that indicates whether or not to permit migration of data to another site in a country, and the field 610 stores overseas migration permission information that indicates whether or not to permit migration of data to another site outside a country. The domestic migration permission information and the overseas migration permission information indicate “permit” when the migration is permitted, and indicate “not-permitted” when the migration is not permitted.

Note that, in addition to the fields 601 to 610, the metadata DB 600 may include a field that stores other information such as a field that stores a label indicating data contents as information used for searching metadata.

The description returns to explanation of FIG. 1. The application platform 100 includes a memory 110 that stores various programs and information, and a CPU 120 that is a processor that reads a program stored in the memory 110, executes this read program, and implements various functions.

In the present embodiment, the memory 110 stores a model management program 111, a metadata management program 112, and an allocation optimization program 113. Furthermore, the memory 110 stores as management information a resource management table 700, an inter-site network management table 800, an app management table 900, an app performance model management table 1000, app performance models 1100, a data store management table 1200, a data store performance model management table 1300, data store performance models 1400, an electric power consumption model management table 1500, and electric power consumption models 1600.

The model management program 111 creates and manages various models related to programs (that are more specifically the apps 251 and the data stores 252) executed by the computer nodes used at each site 200. The metadata management program 112 manages metadata related to data distributed to and managed by the respective sites 200. Based on the management information and the metadata managed by the metadata management program 112, the allocation optimization program 113 creates a container/data allocation plan that is an allocation plan indicating allocation of a program execution platform and data, and transmits a deployment request and a data migration request that are based on this container/data allocation plan to each site 200. The container/data allocation plan indicates, for example, an allocation site that is the site 200 at which each of the execution platform and the data is allocated, and an infrastructure or a computer node at which each of the execution platform and the data at the allocation site is allocated.

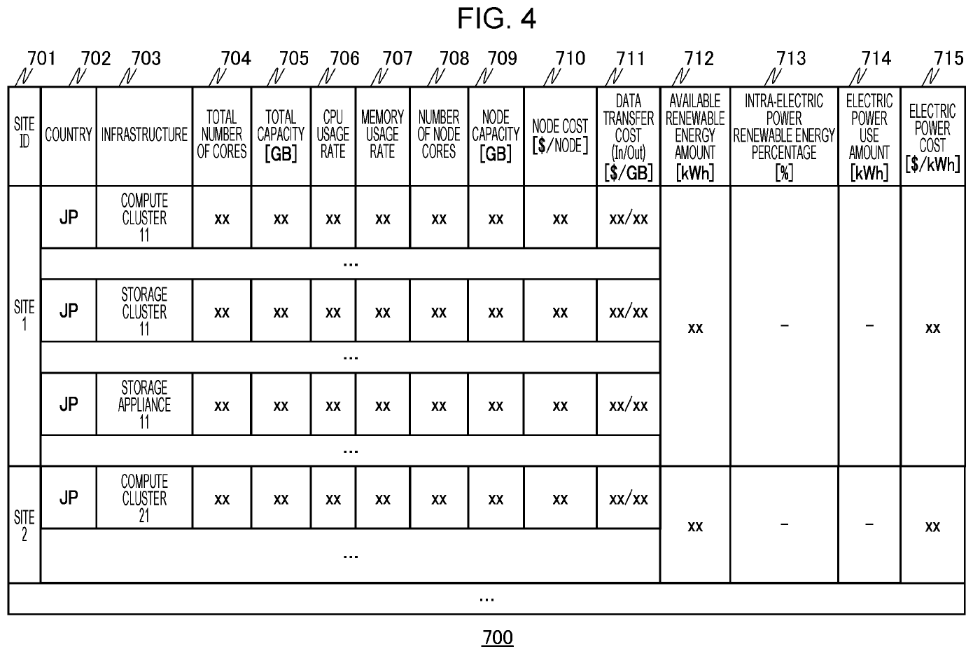

FIG. 4 is a diagram illustrating an example of the resource management table 700. The resource management table 700 is information for managing HW resource information related to hardware resources of each site 200, and electric power resource information related to an electric power status at each site 200, and includes fields 701 to 715.

The field 701 stores site IDs that are identification information for identifying the sites 200. The field 702 stores country codes that indicate countries in which the sites 200 are installed.

The fields 703 to 711 store HW resource information. More specifically, the field 703 stores infrastructure IDs for identifying infrastructures installed at the sites 200. The fields 704 to 709 store information that indicate HW resources included in infrastructures. More specifically, the field 704 stores the total numbers of cores that are sums of the numbers of cores of CPUs included in the computer nodes in the infrastructures. The field 705 stores total capacities that are sums of capacities of memories included in the computer nodes in the infrastructures. The field 706 stores usage rates of the CPUs of the computer nodes in the infrastructures. The field 706 stores usage rates of the memories included in the computer nodes in the infrastructures. The field 708 stores the numbers of node cores that are the numbers of cores per computer node in the infrastructures. The field 709 stores node memory capacities that are capacities of memories per computer node in the infrastructures. Note that, in the present embodiment, the number of cores of the CPUs and the capacities of the memories are the same per computer node.

The field 710 stores node costs that are costs borne by users per computer node. Note that the node cost is provided to the user per computer node in the present embodiment. The field 711 stores data transfer costs that are costs related to data transfer at the sites 200.

The fields 712 to 715 store electric power resource information. More specifically, the field 712 stores available renewable energy amounts (available renewable energy amounts) that are the electric power amounts of the renewable energy available at the sites 200. The field 713 stores intra-electric power renewable energy percentages (intra-power renewable energy percentages) that are ratios of an available renewable energy amount to a total electric power amount available at the site 200. The field 714 stores current electric power use amounts at the sites 200. The field 715 stores electric power costs that are costs related to use of electric power.

Note that the electric power cost may be divided into a cost of the electric power amount of renewable energy, and costs of other electric power amounts. Furthermore, one of the available renewable energy amount and the intra-electric power renewable energy percentage may be stored. Note that there are a case where the available renewable energy amount is determined, and a case where the intra-electric power renewable energy percentage is determined depending on the site 200. Furthermore, there is also a case where both of the available renewable energy amount and the intra-electric power renewable energy percentage are not determined.

Furthermore, in order to manage the HW resource information and the electric power resource information per user or user group, the memory 110 may store the resource management table 700 per user or user group.

Instead of or in addition to the current available renewable energy amount and the intra-electric power renewable energy percentage, the resource management table 700 may include electric power prediction information that indicates prediction values obtained by predicting a future available renewable energy amount and intra-electric power renewable energy.

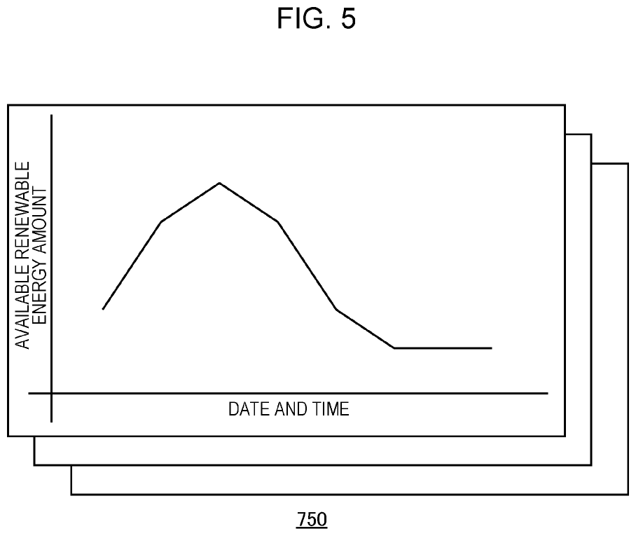

FIG. 5 is a diagram illustrating an example of electric power prediction information. FIG. 5 illustrates an example of electric power prediction information 750 of an available renewable energy amount. The electric power prediction information 750 is created per site 200, and indicates a correspondence relationship between a future date and time and an available renewable energy amount at this site 200. The electric power prediction information 750 may be prediction information of an electric power generation amount provided by an electric power company that supplies electric power or information created from this prediction information, or may be information calculated using a machine learning model or the like that predicts time-series changes in usage rates of the CPUs and the memories in the site 200. Furthermore, the electric power prediction information 750 may be created by one of the computer nodes in the site 200, or may be created outside the site 200 (including the application platform 100 and the like).

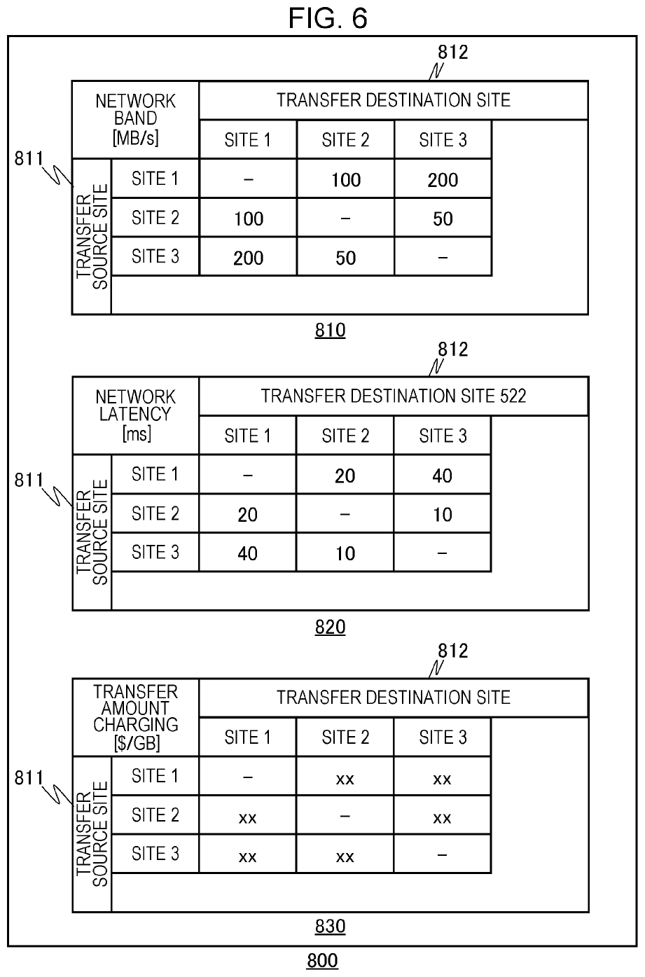

FIG. 6 is a diagram illustrating an example of the inter-site network management table 800. The inter-site network management table 800 is information related to communication between the sites 200, and includes a network band management table 810, a network latency management table 820, and a network transfer charging management table 830.

The network band management table 810 indicates a network band between a transfer source site 811 that is the site 200 that is a data transfer source and a transfer destination site 812 that is a data transfer destination per combination of the sites 200 (base IDs).

The network latency management table 820 indicates network latency that is latency between the transfer source site 811 and the transfer destination site 812 per combination of the sites 200.

The network transfer charging management table 830 indicates transfer amount charging that is a charge related to communication between the transfer source site 811 and the transfer destination site 812 per combination of the sites 200.

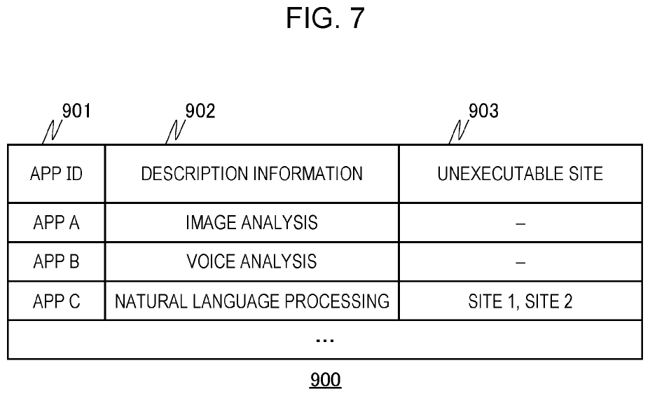

FIG. 7 is a diagram illustrating an example of the app management table 900. The app management table 900 includes fields 901 to 903. The field 901 stores app IDs that are identification information for identifying the apps 251. The field 902 stores description information that indicates items of contents of processing performed by the apps 251. The field 903 stores site IDs of execution not-permitted sites that are the sites 200 at which execution of the apps 251 is not permitted.

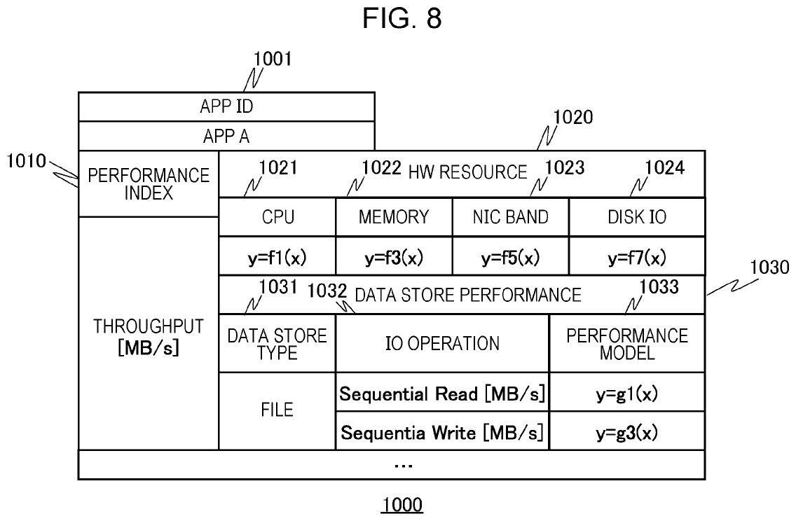

FIG. 8 is a diagram illustrating an example of the app performance model management table 1000. The app performance model management table 1000 is information for managing the app performance models 1100. The app performance models 1100 include a first performance model that indicates a relationship between performance of the app 251 and an HW resource amount necessary for realizing this performance, and a third performance model that indicates a relationship with performance of the data store 252 necessary for realizing the performance of the app 251.

The app performance model management table 1000 includes information for managing the app performance model 1100 of the app 251 per app 251. FIG. 8 illustrates the app performance model management table 1000 related to the app 251 of an app ID “app A”.

The app performance model management table 1000 includes fields 1001, 1010, 1020, and 1030. The field 1001 stores an app ID for identifying the management target app 251. The field 1010 stores a performance index that indicates performance of the management target app 251. One of throughputs is illustrated as the performance index in the example in FIG. 8. However, there may be a plurality of the performance indices. For example, the performance indices may include response performance [ms], latency, and the like. The field 1020 stores the app performance model 1100 (first performance model) per HW resource to be allocated to the app 251. More specifically, the field 1020 includes a field 1021 that stores the app performance model 1100 for the CPU (the number of cores), a field 1022 that stores the app performance model 1100 for the memory (capacity), a field 1023 that stores the app performance model 1100 for the NIC band, and a field 1024 that stores the app performance model 1100 for the IO band of the disk.

The field 1030 stores the app performance model 1100 (third performance model) per IO operation executed by the management target app 251 via the data store 252. More specifically, the field 1030 includes a field 1031 that stores a type of the data store 252 to be allocated to the management target app 251, a field 1032 that stores types of IO operations executed by the data store 252 to be allocated to the app 251, and a field 1033 that stores the app performance model 1100 (third performance model) supporting the types of the IO operations. The IO operations are, for example, sequential read, sequential read write, random read, random write, and the like.

Note that the app performance model 1100 may be created per infrastructure similarly to the electric power consumption models 1600 described later. This is because performance characteristics of HW resources such as a CPU or the like may be different per infrastructure. Furthermore, the app performance model 1100 may be created per data type accessed (read/write) by the app 251. The data type may be a database, a file, a block, or the like, may be an image file, a movie file, an audio file, or the like, or may be a setting file, an analysis target file, or the like. Furthermore, when the app 251 is executed using a specific algorithm selected from a plurality of algorithms, the app performance model 1100 may be created per algorithm. The app 251 of this type includes an application that performs compression in one compression format of a plurality of compression formats, an application that changes an algorithm according to an analysis target data type, and the like.

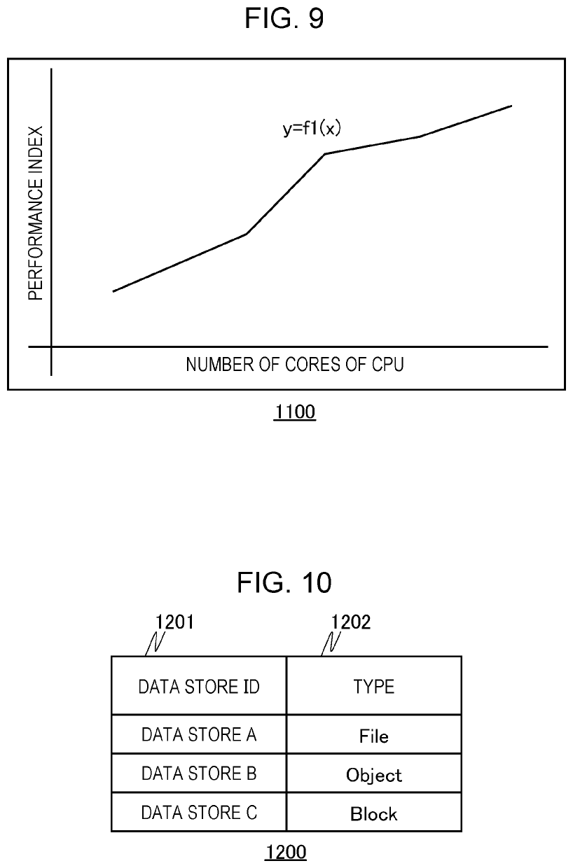

FIG. 9 is a diagram illustrating an example of the app performance model 1100.

The example in FIG. 9 illustrates an example of the first performance model among the app performance models 1100. More specifically, an expression y=f1 (x) of an approximate curve of a graph indicating a relationship between a resource allocation amount (here, the number of cores of the CPU) and performance (performance index) is created as the app performance model 1100 illustrated in FIG. 9. Here, y represents app performance, and x represents a resource allocation amount. For example, an existing program such as spreadsheet software can be used to create a graph and derive the equation of the approximate curve.

Note that the app performance model 1100 illustrated in FIG. 9 is merely an example, and is not limited to this example. For example, the app performance model 1100 may be table data in which all of measured performance indices are recorded per resource allocation amount, a machine learning model (e.g., neural network) that is constructed by learning a relationship between a measured performance index and a resource allocation amount, or the like.

FIG. 10 is a diagram illustrating an example of the data store management table 1200. The data store management table 1200 is information for managing the data store 252, and includes fields 1201 and 1202. The field 1201 stores data store IDs that are identification information for identifying the data stores 252. The field 1202 stores storage types supported by the data stores 252 as the types of the data stores 252.

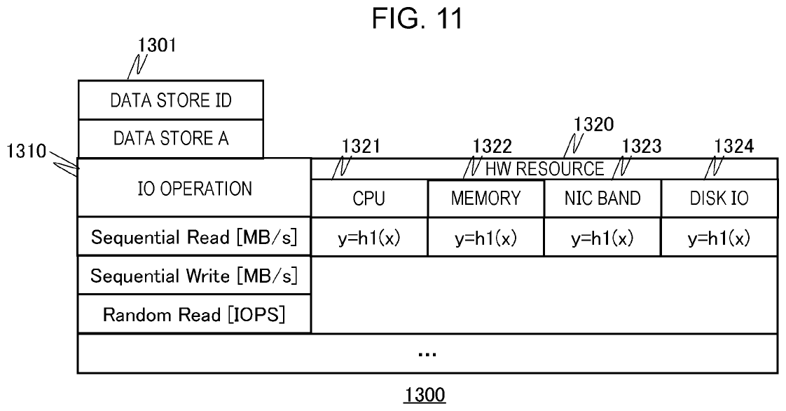

FIG. 11 is a diagram illustrating an example of the data store performance model management table 1300. The data store performance model management table 1300 is information for managing the data store performance models 1400. The data store performance model 1400 is a second performance model that indicates a relationship between performance of the data store 252 and an HW resource amount necessary for realizing this data store 252.

The data store performance model management table 1300 includes information that manages the data store performance model 1400 of each data store 252 per data store 252. FIG. 11 illustrates the data store performance model management table 1300 related to the data store 252 of a data store ID “data store A”.

The data store performance model management table 1300 includes fields 1301, 1310, and 1320. The field 1301 stores a data store ID. The field 1310 stores types of IO operations executed by the data store 252. The field 1320 stores the data store performance model 1400 supporting the types of IO operations per HW resource to be allocated to the target data store 252. More specifically, the field 1320 includes a field 1021 that stores the data store performance model 1400 for the CPU (the number of cores), a field 1322 that stores the data store performance model 1400 for the memory (capacity), a field 1323 that stores the data store performance model 1400 for the NIC band, and a field 1324 that stores the data store performance model 1400 for the IO band of the disk.

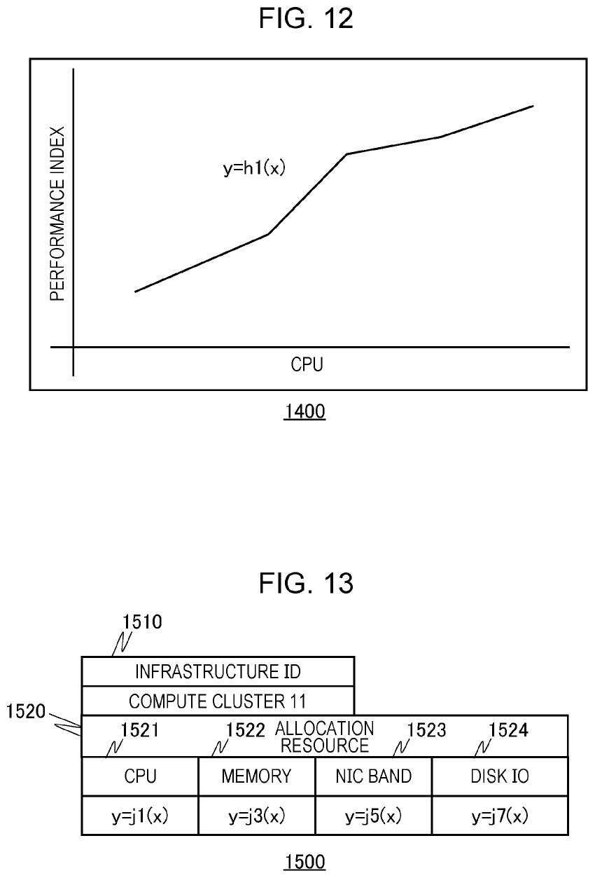

FIG. 12 is a diagram illustrating an example of the data store performance model 1400.

In the example in FIG. 12, an expression y=h1 (x) of an approximate curve of a graph indicating a relationship between a resource allocation amount (here, the number of cores of the CPU) and the performance (performance index) is created as the data store performance model 1400. Here, y represents performance of a data store, and x represents a resource allocation amount. For example, an existing program such as spreadsheet software can be used to create a graph and derive the equation of the approximate curve. The performance index of the data store 252 is, for example, a throughput or the like.

Note that the data store performance model 1400 illustrated in FIG. 12 is merely an example, and is not limited to this example. For example, the data store performance model 1400 may be table data in which all of measured performance indices are recorded per resource allocation amount, a machine learning model (e.g., neural network) that is constructed by learning a relationship between a measured performance index and a resource allocation amount, or the like.

FIG. 13 is a diagram illustrating an example of the electric power consumption model management table 1500. The electric power consumption model management table 1500 is information for managing the electric power consumption models 1600. The electric power consumption model 1600 is a model that indicates a relationship between a resource allocation amount that is a resource amount of an HW resource allocated to target programs (the app 251 and the data store 252), and an electric power consumption amount that is consumed when these target programs are executed.

The electric power consumption model management table 1500 includes information for managing the electric power consumption model 1600 supporting each infrastructure per infrastructure. This is because electric power efficiency is different per infrastructure. FIG. 13 illustrates the electric power consumption model management table 1500 related to an infrastructure of an infrastructure ID “computer cluster 11”.

The electric power consumption model management table 1500 includes fields 1510 and 1520. The field 1510 stores an infrastructure ID. The field 1520 stores the electric power consumption model 1600 per HW resource to be allocated to a target program. More specifically, the field 1520 includes a field 1521 that stores the electric power consumption model 1600 for the CPU (the number of cores), a field 1522 that stores the electric power consumption model 1600 for the memory (capacity), a field 1523 that stores the electric power consumption model 1600 for the NIC band, and a field 1524 that stores the electric power consumption model 1600 for the IO band of the disk.

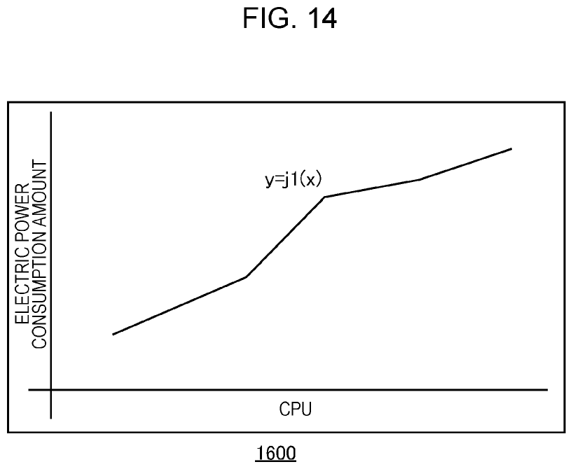

FIG. 14 is a diagram illustrating an example of the electric power consumption model 1600.

In the example in FIG. 14, an equation y=j1 (x) of an approximate curve of a graph indicating a relationship between a resource allocation amount (here, the number of cores of the CPU) and an electric power consumption amount is created as the electric power consumption model 1600. In this regard, y represents an electric power consumption amount, and x represents a resource allocation amount. For example, an existing program such as spreadsheet software can be used to create a graph and derive the equation of the approximate curve.

Note that the electric power consumption model 1600 illustrated in FIG. 14 is merely an example, and is not limited to this example. For example, the electric power consumption model 1600 may be table data in which all of measured electric power consumption amounts are recorded per resource allocation amount, and a machine learning model (e.g., neural network) that is constructed by learning a relationship between a measured electric power consumption amount and a resource allocation amount, or the like.

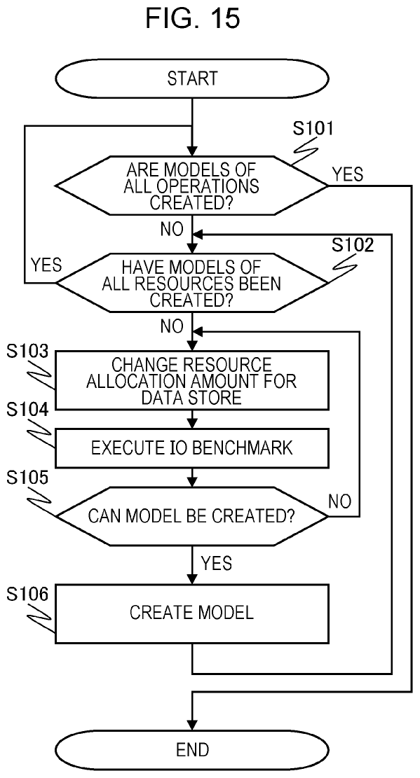

FIG. 15 is a flowchart for describing an example of data store performance model creation processing of creating the data store performance models 1400. The data store performance model creation processing is executed with respect to the new data store 252 as a creation target of the data store performance model 1400 when the new data store 252 is introduced into the computer system.

According to the data store performance model creation processing, the model management program 111 of the application platform 100 first checks whether or not the data store performance models 1400 have been created for all of the IO operations executed by the target data store that is the data store that is the creation target of the data store performance model 1400 (step S101). In a case where the data store performance models 1400 have been created for all of the IO operations (step S101: Yes), the model management program 111 ends the processing.

In a case where the data store performance model 1400 is not created for any one of the IO operations (step S101: No), the model management program 111 decides whether or not the data store performance models 1400 for all of the HW resources have been created for the target IO operation that is one of the IO operations for which the data store performance model 1400 is not created (step S102). In a case where the data store performance models 1400 for all of the HW resources have been created (step S102: Yes), the model management program 111 returns to the processing in step S101.

In a case where the data store performance model 1400 for any one of the HW resource is not created (step S102: No), the model management program 111 creates the data store performance model 1400 for the target HW resource that is any one of the HW resources for which the data store performance model 1400 is not created. More specifically, the model management program 111 first outputs an instruction for changing the resource allocation amount allocated to the target data store for the target HW resource to a target infrastructure that is an infrastructure that executes the target data store, and changes the resource allocation amount (step S103). Note that the HW resource amount other than the target HW resource is, for example, a predetermined allocation amount that does not become a bottleneck of performance of the target data store. Resources can be allocated to the infrastructure by using an existing program. For example, a resource allocation program that is called Cgroups provided to a Linux (registered trademark) operating system can be used for resource allocation.

Subsequently, the model management program 111 causes the target data store of the target infrastructure to execute the IO benchmark, and executes performance measurement of the target data store (step S104). Performance measurement of the target data store is processing of measuring performance of the target data store for the target IO operation, and is more specifically processing of measuring a performance index obtained by evaluating the performance of the target data store.

Furthermore, the model management program 111 decides whether or not the number of times of execution of performance measurement for the target IO operation is a threshold or more (step S105). The threshold described herein is, for example, the number of times of execution necessary for creating the data store performance model 1400, and is determined in advance.

In a case where the number of times of execution is less than the threshold (step S105: No), the model management program 111 returns to the processing in step S103, and changes the resource allocation amount of the target HW resource to be allocated to the target data store again. The resource allocation amount can be changed by, for example, increasing or decreasing the resource allocation amount by a predetermined amount from an initial value. The initial value and the predetermined amount are determined in advance, for example.

In a case where the number of times of execution is the threshold or more (step S105: Yes), the model management program 111 creates the data store performance model 1400 for the target HW resource of the target IO operation of the target data store based on a measurement result of the performance measurement, registers the data store performance model 1400 in the data store performance model management table 1300 (step S106), and returns to the processing in step S102.

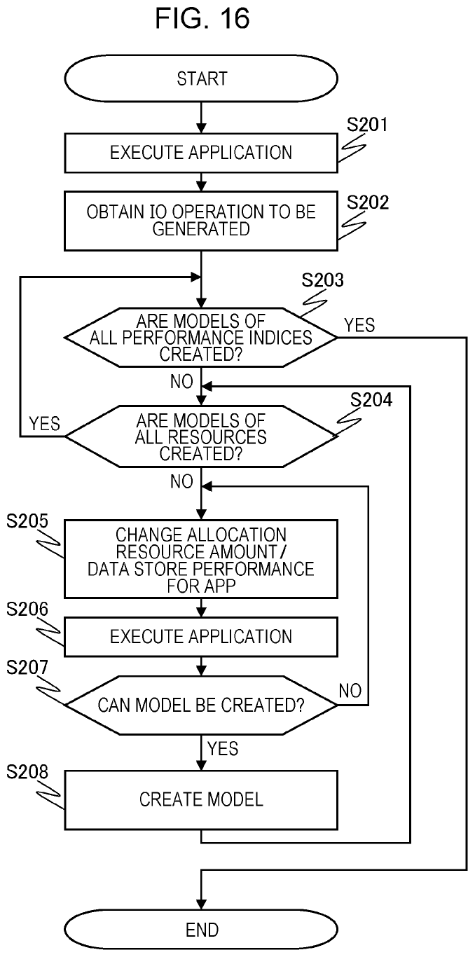

FIG. 16 is a flowchart for describing an example of app performance model creation processing of creating the app performance models 1100. The app performance model creation processing is executed with respect to the new app 251 as a creation target of the app performance model 1100 when this new app 251 is introduced into the computer system.

According to the app performance model creation processing, the model management program 111 of the application platform 100 first causes a target app that is the app 251 as the creation target of the app performance model 1100 to be executed (step S201). An execution destination of the target app may be one of the compute nodes 300 at each site 200.

The model management program 111 monitors an output of the executed target app, and detects an IO operation generated by the target app as a generated IO operation (step S202). At this time, for example, the model management program 111 causes the target app to be executed for a predetermined period, and detects the IO operation generated during this predetermined period as the generated IO operation.

Thereafter, the model management program 111 checks whether or not the app performance models 1100 for all of the performance indices have been created (step S203). In a case where the app performance models 1100 for all of the performance indices have been created (step S203: Yes), the model management program 111 ends the processing.

In a case where the app performance model 1100 is not created for any one of the performance indices (step S203: No), the model management program 111 checks whether or not the app performance models 1100 for all resources have been created for a target performance index that is one of the performance indices for which the app performance model 1100 is not created (step S204). In this regard, the resources are HW resources and generated IO operations. In a case where the app performance models 1100 for all resources have been created (step S204: Yes), the model management program 111 returns to the processing in step S203.

In a case where the app performance model 1100 is not created for any one of the resources (step S204: No), the model management program 111 creates the app performance model 1100 for the target resource that is a resource for which the app performance model 1100 is not created. More specifically, the model management program 111 first causes a target infrastructure to change the resource allocation amount for the target resource (step S205). At this time, in a case where the target resource is the IO operation of the data store 252, the model management program 111 changes the resource allocation amount allocated to the data store 252 using the data store performance model 1400 of this data store 252, and thereby changes performance of the IO operation. Furthermore, when the app performance model 1100 is commonly created for all of the compute clusters 30, the target infrastructure may be one of the compute clusters 30. Furthermore, when the app performance model 1100 is created per compute cluster 30, all of the compute clusters 30 are the target infrastructures.

Subsequently, the model management program 111 outputs an execution instruction of the target app to the target infrastructure, causes the target infrastructure to execute the target app, and measures a target performance index of the target app (step S206).

Furthermore, the model management program 111 decides whether or not the number of times of execution of performance measurement for the target app is the threshold or more (step S207). The threshold described herein is, for example, the number of times of execution necessary for creating the app performance models 1100, and is determined in advance.

In a case where the number of times of execution is less than the threshold (step S207: No), the model management program 111 returns to the processing in step S204.

In a case where the number of times of execution is the threshold or more (step S207: Yes), the model management program 111 creates the app performance model 1100 for the target resource of the target performance index in the target app based on the measurement result of the performance measurement, registers the app performance model 1100 in the app performance model management table 1000 (step S208), and returns to the processing in step S204.

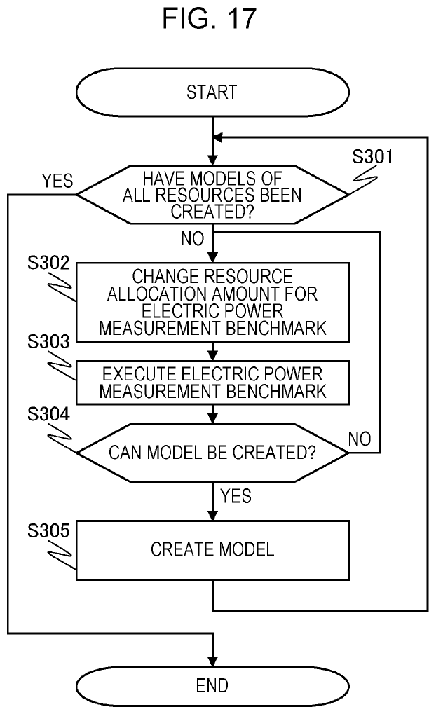

FIG. 17 is a flowchart for describing an example of electric power consumption model creation processing of creating the electric power consumption models 1600. The electric power consumption model creation processing is executed with respect to a new infrastructure as a creation target of the electric power consumption model 1600 when this new infrastructure is introduced into the computer system.

According to the electric power consumption model creation processing, the model management program 111 of the application platform 100 first checks whether or not the electric power consumption models 1600 for all of the HW resources have been created for an infrastructure as a creation target of the electric power consumption model 1600 (step S301). In a case where the electric power consumption models 1600 for all of the HW resources have been created (step S301: Yes), the model management program 111 ends the processing.

In a case where the electric power consumption model 1600 is not created for any one of the HW resources (step S301: No), the model management program 111 creates the electric power consumption model 1600 for the target HW resource that is the HW resource for which the electric power consumption model 1600 is not created. More specifically, the model management program 111 first changes the resource allocation amount allocated to an electric power measurement benchmark for executing benchmark processing for electric power estimation at the target infrastructure (step S302). The electric power measurement benchmark is specifically a program that executes the benchmark processing of measuring performance of an HW resource by using an allocated resource allocation amount at maximum. The resource allocation amount allocated to the electric power measurement benchmark corresponds to a use amount used by the benchmark processing.

Subsequently, the model management program 111 outputs an electric power measurement benchmark execution instruction to the target infrastructure, causes the target infrastructure to execute the benchmark processing, and measures the electric power consumption amount with respect to the resource allocation amount of the target HW resource (step S303). At this time, the model management program 111 obtains the electric power consumption amount of the target infrastructure, and measures an increase amount before execution of the benchmark processing from the electric power consumption amount at a time of the execution as the electric power consumption amount with respect to the resource allocation amount.

Furthermore, the model management program 111 decides whether or not the number of times of execution of electric power measurement for the target HW resource is the threshold or more (step S304). The threshold described herein is, for example, the number of times of execution necessary for creating the electric power consumption model, and is determined in advance.

In a case where the number of times of execution is less than the threshold (step S304: No), the model management program 111 returns to the process in S302, and changes the resource allocation amount allocated to the target HW resource again. The resource allocation amount can be changed by, for example, increasing or decreasing the resource allocation amount by a predetermined amount from an initial value. The initial value and the predetermined amount are determined in advance, for example.

In a case where the number of times of execution is the threshold or more (step S304: Yes), the model management program 111 creates the electric power consumption model 1600 for the target HW resource based on the measurement result of the electric power measurement, registers the electric power consumption model 1600 in the electric power consumption model management table 1500 (step S305), and returns to the processing in step S310.

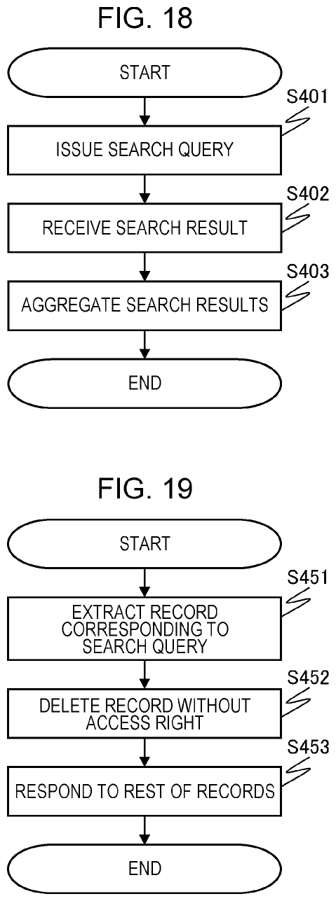

FIG. 18 is a flowchart for describing an example of inter-distributed site metadata search processing by the metadata management program 112 of the application platform 100. The inter-distributed site metadata search processing is executed when, for example, a metadata search request is received from the user via the client program 162 of the host 150.

According to the inter-distributed site metadata search processing, the metadata management program 112 first issues a search query of the metadata DB 600 to each site 200 (step S401). Thereafter, the metadata management program 112 receives a search result matching the search query from each site 200 (step S402). The metadata management program 112 creates an inter-distributed site metadata search result obtained by aggregating search results from the respective sites 200, responds to the user via the client program 162 of the host 150 (step S403), and ends the processing. Note that the inter-distributed site metadata search result may be recorded in the memory 110 of the application platform 100 or the like.

FIG. 19 is a diagram for describing an example of the intra-site metadata search processing that is processing on a side that has received the search query in step S401. The intra-site metadata search processing is executed when, for example, a search query is received by the distributed metadata management program 215 of one of the computer nodes (such as the computer node holding the metadata DB 600) in the site 200.

According to the intra-site metadata search processing, the distributed metadata management program 215 searches the record corresponding to the search query from the metadata DB 600 in the own site (step S451). The distributed metadata management program 215 deletes from searched records a record to which the user of the search source does not have an access right (step S452). The distributed metadata management program 215 creates a record remaining without being deleted as a search result of the search query, responds to the storage appliance 50 (step S453), and ends the processing. Note that the access right is managed at, for example, each site 200.

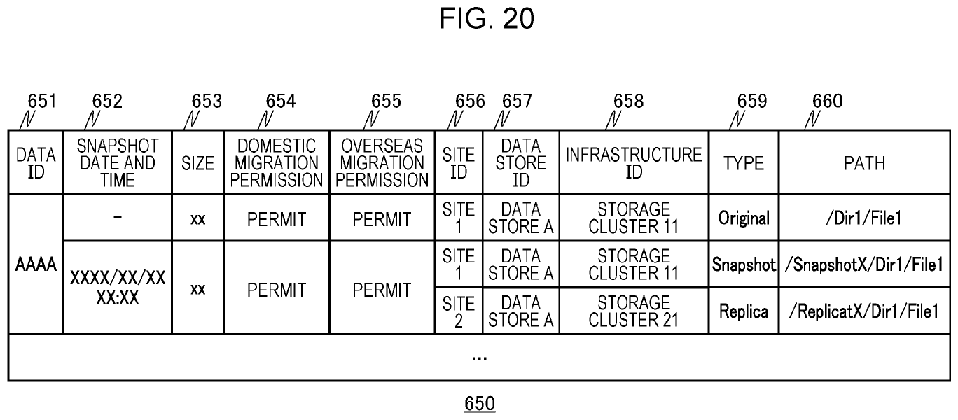

FIG. 20 is a diagram for describing an example of an inter-distributed site metadata search result. An inter-distributed site metadata search result 650 illustrated in FIG. 20 includes fields 651 to 660.

The field 651 stores a data ID for identifying data. The field 652 stores snapshot dates and times of data. The field 652 stores data sizes. The field 654 stores domestic data migration permission information. The field 655 stores overseas data migration permission information. The field 656 stores site IDs that indicate sites that store data. The field 657 stores data store IDs for identifying data stores associated with data. The field 658 stores infrastructure IDs for identifying infrastructures that execute data stores associated with data. The field 659 stores data types. The field 660 stores path information of data.

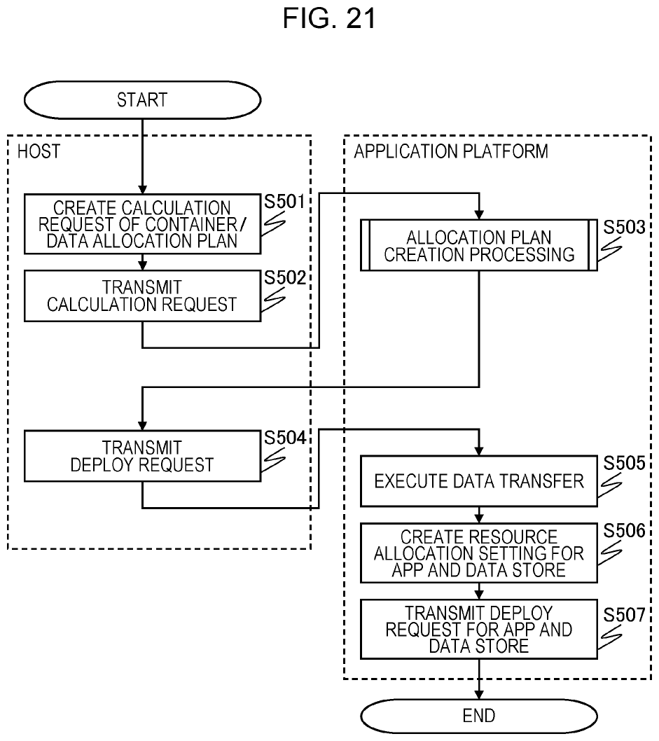

FIG. 21 is a flowchart for describing an example of app deployment processing of deploying the app 251 and the data store 252.

According to the app deployment processing, the client program 162 of the host 150 first accepts a deployment condition that is a condition for deploying the app 251 and the data store 252 from the user, and creates a calculation request for a container/data allocation plan matching this deployment condition (step S501). The client program 162 transmits the created calculation request to the application platform 100 (step S502).

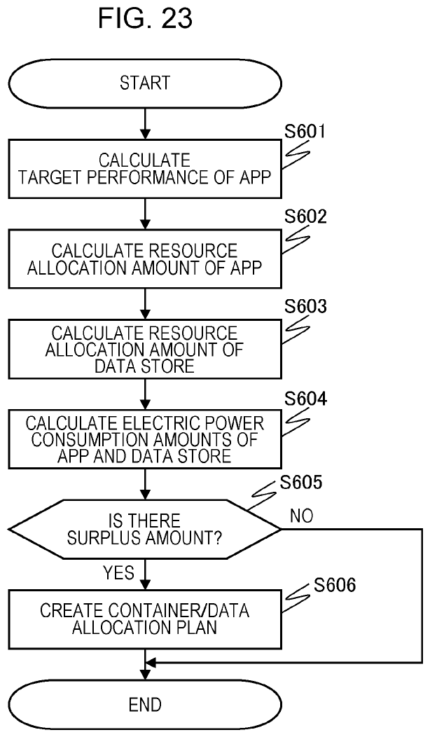

The allocation optimization program 113 of the application platform 100 receives the calculation request, and executes allocation plan creation processing (see FIG. 23) of creating a container/data allocation plan based on this calculation request and returning the container/data allocation plan to the host 150 (step S503).

The client program 162 of the host 150 receives the container/data allocation plan, and displays this container/data allocation plan. Thereafter, when receiving information indicating that the container/data allocation plan is approved, the client program 162 transmits a deployment request for requesting deployment that is based on the container/data allocation plan to the application platform 100 (step S504). Note that, in a case where the container/data allocation plan is not approved, the client program 162 returns to the processing in step S501.

When receiving the deployment request, the allocation optimization program 113 of the application platform 100 transmits a data migration request that is based on the container/data allocation plan to a site of a data transfer source, and transfers the data migration request to the site of the data transfer destination (step S505). For example, the allocation optimization program 113 transmits the data migration request to the inter-site data control program 214 of the storage node 400 that executes the data store 252 associated with the data to be transferred in the site 200 that is the data transfer source, and thereby causes this inter-site data control program 214 to transfer the data.

The allocation optimization program 113 creates a setting file (e.g., a manifest file of a container or the like) related to a resource allocation amount of an HW resource for the app 251 and the data store 252 according to the deployment request (step S506). The allocation optimization program 113 transmits the deployment request to which the setting file has been added, to an allocation site indicated by the container/data allocation plan (step S507), and ends the processing.

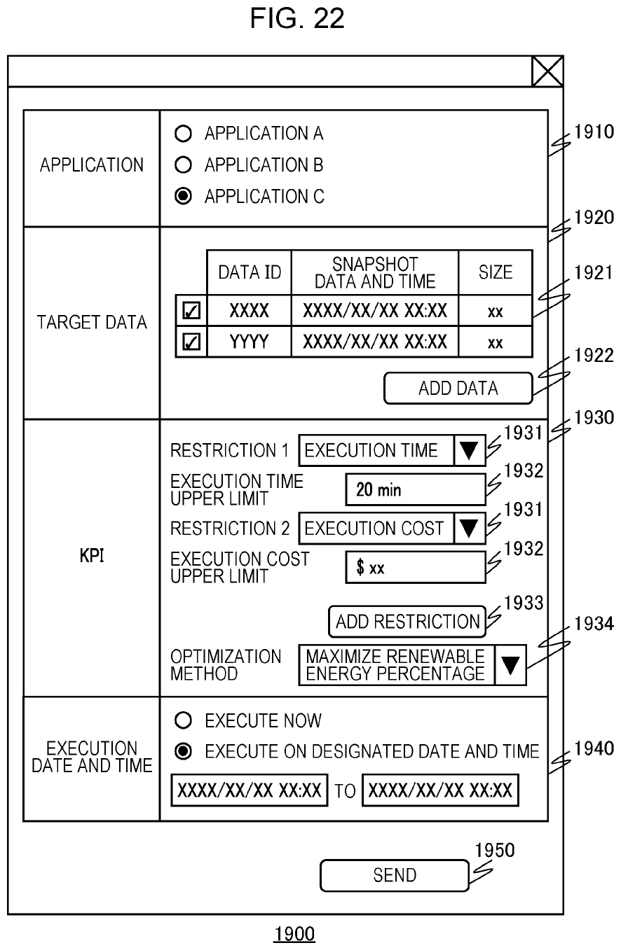

FIG. 22 is a diagram illustrating an example of a container/data allocation plan calculation request screen for the user to input a deployment condition.

The container/data allocation plan calculation request screen 1900 illustrated in FIG. 22 includes an application selection field 1910, a data selection field 1920, a Key Performance Indicator (KPI) input field 1930, an execution date and time input field 1940, and a send button 1950.

The application selection field 1910 is an interface for selecting the app 251 as a target in which the execution platform is allocated. The data selection field 1920 is an interface for selecting data that is a use target in the target app 251, and includes a list 1921 that indicates a list of use target data, and an add button 1922 that adds use target data.

The KPI input field 1930 is an interface for inputting a KPI that is target performance information indicating target performance that is a target value for performance of the app 251, and includes a selection field 1931 for selecting a KPI type, an input field 1932 for inputting the selected KPI type, an add button 1933 for adding the KPI type to be input, and a method selection field 1934 for selecting an optimization method. The optimization method is information that designates optimization processing when the container/data allocation plan is created by the allocation plan creation processing in step S503 in FIG. 21, and indicates, for example, maximization of an intra-electric power renewable energy percentage, maximization of an available renewable energy amount, minimization of an electric power cost, or the like.

The execution date and time input field 1940 is an interface for inputting a timing to execute deployment, and enables selection of a current time (now) and settings of an arbitrary date and time in the example in FIG. 22. The send button 1950 is a button for transmitting the input deployment condition.

FIG. 23 is a flowchart for describing an example of the allocation plan creation processing in step S503 of FIG. 21.

According to the allocation plan creation processing, the allocation optimization program 113 calculates the target performance of the app 251 based on the KPI included in the calculation request (step S601). For example, in a case where the KPI is an execution time of the app 251, the allocation optimization program 113 calculates a throughput, response performance, latency, and the like that satisfy this execution time as the target performance.

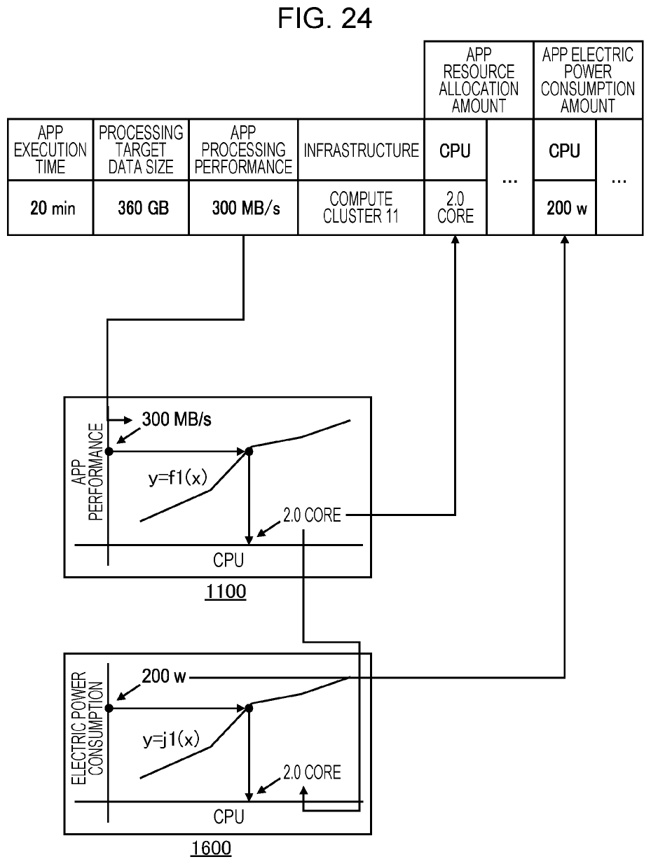

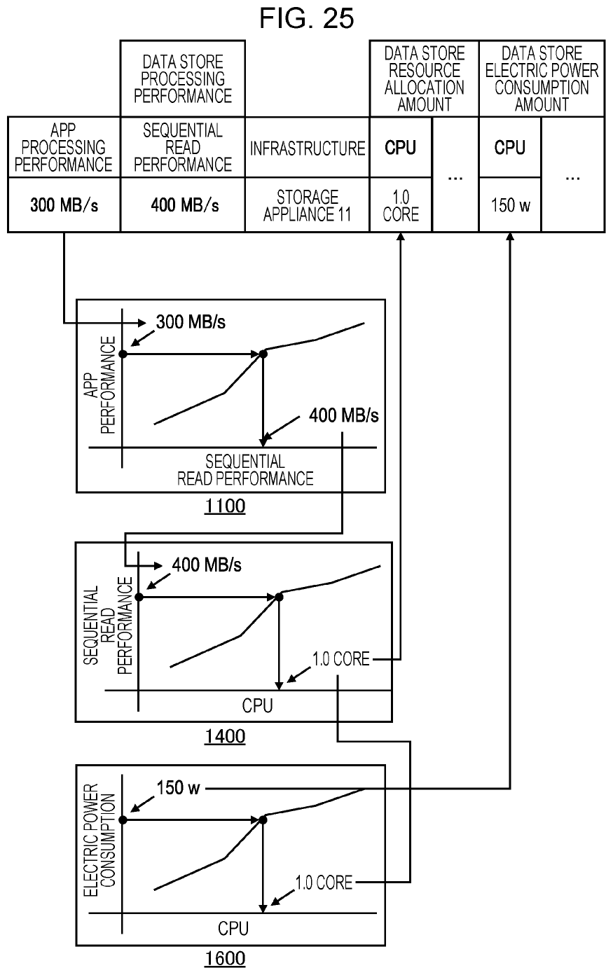

The allocation optimization program 113 executes first calculation processing (see FIG. 24) of calculating a necessary allocation amount that is a resource allocation amount to be allocated to the app 251 per infrastructure of each site based on the target performance of the app 251 (step S602). Furthermore, the allocation optimization program 113 executes second calculation processing (see FIG. 25) of calculating a necessary allocation amount that is a resource allocation amount to be allocated to the data store 252 per infrastructure of each site based on the target performance of the app 251 (step S603). Furthermore, the allocation optimization program 113 executes third calculation processing (see FIGS. 24 and 25) of calculating necessary electric power consumption amounts of the app 251 and the data store 252 based on the target performance of the app 251 (step S604).

Based on the resource management table 700, the allocation optimization program 113 decides whether or not there is a deployable site that is the site 200 having a surplus of the resource amount and the electric power amount corresponding to the necessary allocation amount and the necessary electric power consumption amount (step S605). In a case where there is not the deployable site (step S605: No), the allocation optimization program 113 ends the processing without deploying a container that is the execution platform.

In a case where there is the deployable site (step S605: Yes), the allocation optimization program 113 executes the optimization processing by the optimization method designated on the container/data allocation plan calculation request screen 1900 based on the necessary allocation amount and the necessary electric power consumption amount, and the resource management table 700, creates the container/data allocation plan (step S606), and ends the processing. The optimization processing may use other information as needed. The other information is, for example, the inter-distributed site metadata search result 650 (that is more specifically the app 251 and restriction information related to migration of data). Furthermore, the optimization processing may use software such as a mathematical programming solver, or may use an algorithm that is based on machine learning or the like.

FIG. 24 is a diagram for describing an example of processing of calculating a resource allocation amount and an electric power consumption amount of the app 251.

As illustrated in FIG. 24, the allocation optimization program 113 calculates a resource amount (that is the number of cores of the CPU herein) matching the target performance of the app 251 as a necessary allocation amount that is a resource allocation amount of the app 251 necessary for realizing the target performance by using the app performance model 1100.

Furthermore, the allocation optimization program 113 calculates the electric power consumption amount matching the calculated resource allocation amount as the necessary electric power consumption amount by using the electric power consumption model 1600 of the CPU.

FIG. 25 is a diagram for describing an example of processing of calculating a resource allocation amount and an electric power consumption amount of the data store 252.

As illustrated in FIG. 25, the allocation optimization program 113 first calculates supporting performance that is IO operation performance matching the target performance of the app 251 by using the app performance model 1100 (third performance model). Subsequently, by using the data store performance model 1400, the allocation optimization program 113 calculates a resource amount (that is the number of cores of the CPU herein) matching the IO operation supporting performance as a necessary allocation amount that is a resource allocation amount of the data store 252 necessary for realizing the target performance.

Furthermore, the allocation optimization program 113 calculates the electric power consumption amount matching the resource allocation amount as the necessary electric power consumption amount by using the electric power consumption model 1600 of the CPU.

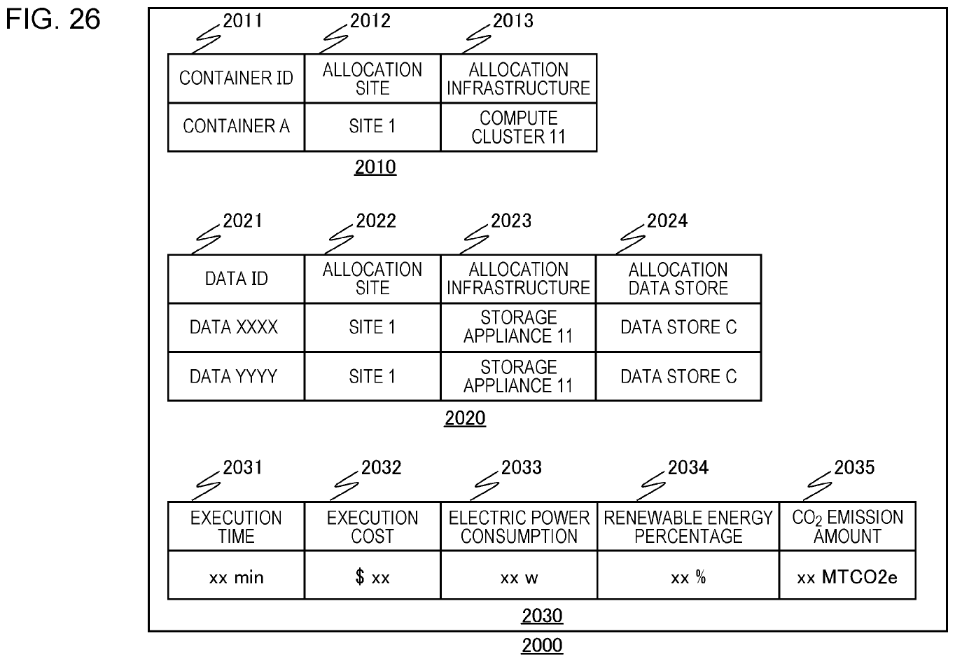

FIG. 26 is a diagram illustrating an application execution plan table that is the example of the container/data allocation plan.

An application execution plan table 2000 illustrated in FIG. 26 includes a container allocation plan 2010, a data allocation plan 2020, and an execution time information estimate 2030.

The container allocation plan 2010 is information that indicates an allocation destination in which a container is allocated, and includes fields 2011 to 2013. The field 2011 stores a container ID that is identification information for identifying a container. The field 2012 stores a site ID for identifying an allocation site that is the site 200 at which a container is allocated. The field 2013 stores an infrastructure ID for identifying an allocation infrastructure that is an infrastructure at which a container is allocated.

The data allocation plan 2020 is information that indicates an allocation destination to allocate data, and includes fields 2021 to 2024. The field 2021 stores data IDs for identifying data. The field 2022 stores site IDs for identifying allocation sites that are the sites 200 that store data. In the present embodiment, container allocation sites and data allocation sites are the same. The field 2023 stores infrastructure IDs for identifying allocation infrastructures that are infrastructures for storing data. The field 2024 stores data store IDs for identifying allocation data stores that are data stores for reading and writing data. Note that the data allocation plan 2020 may further include a field that stores infrastructure IDs for identifying infrastructures that execute data stores, and the like.

The execution time information estimate 2030 is information for assisting user's decision on validity of the container/data allocation plan, and includes fields 2031 to 2035. The field 2031 stores a prediction value of the execution time of processing by the app 251. The field 2032 stores an execution cost of the app 251. The field 2033 stores an electric power consumption amount required to execute the app 251. The field 2034 stores a renewable energy percentage (renewable energy percentage) that is a ratio of the electric power amount of the renewable energy to the electric power consumption amount required to execute the app 251. The field 2035 stores a CO₂ emission amount resulting from execution of the app 251. Note that the CO₂ emission amount can be calculated from, for example, the electric power amount of energy other than renewable energy in the electric power consumption amount resulting from execution of the app 251.

As described above, according to the present embodiment, the memory 110 of the application platform 100 stores the performance models (1100 and 1400) that indicate the relationship between the performance of the program and the resource amount of the hardware necessary for realizing the performance of the program, and the electric power consumption model 1600 that indicates the relationship between the resource allocation amount that is the resource amount allocated to the program, and the electric power consumption amount consumed by executing the program per site 200. The CPU 120 receives target performance information that indicates target performance for the program, calculates per site a necessary allocation amount and a necessary electric power consumption amount that are a resource allocation amount and an electric power consumption amount necessary for realizing the target performance by using the target performance information, the performance model, and the electric power consumption model, and creates a container/data allocation plan that is an allocation plan of an execution platform of the program and data based on a result of the calculation. Consequently, it is possible to execute desired processing at an appropriate site that takes an electric power consumption amount into account.

Furthermore, in the present embodiment, the CPU 120 calculates the necessary allocation amount and the necessary electric power consumption amount per infrastructure at each site, and calculates the container/data allocation plan that indicates the infrastructure in which the container and the data are allocated based on a result of the calculation. Consequently, it is possible to execute predetermined processing at an appropriate infrastructure that takes an electric power consumption amount into account.

Furthermore, in the present embodiment, the memory 110 stores electric power resource information related to the electric power status at each site 200. The CPU 120 creates the container/data allocation plan based on the calculation result and the electric power resource information. Consequently, it is possible to execute desired processing at an appropriate site that takes the electric power status at the site 200 into account.

Furthermore, in the present embodiment, the electric power resource information includes at least one of an available renewable energy amount that is an electric power amount of the renewable energy available at the site 200, and an intra-electric power renewable energy percentage that is a ratio of the available renewable energy amount to the total electric power amount available at the site 200. Consequently, it is possible to execute desired processing at an appropriate that takes the electric power amount of renewable energy into account.

Furthermore, in the present embodiment, the electric power resource information includes a future prediction value of at least one of the available renewable energy amount and the intra-electric power renewable energy percentage. Consequently, it is possible to execute desired processing at an appropriate site that takes a predetermined electric power amount of renewable energy into account.

Furthermore, according to the present embodiment, there are the first performance model related to the first program, the second performance model related to the second program, and the third performance model indicating the relationship with performance of the first program necessary for realizing performance of the second program. Consequently, it is possible to calculate the necessary allocation amount and the necessary electric power consumption amount of both the first program and the second program from the target performance of the second program. Therefore, it is possible to reduce a burden on the user.

Furthermore, according to the present embodiment, the first program is the data store 252, and the second program is the app 251, so that it is possible to execute desired processing at an appropriate site that takes electric power consumption amounts of both of the app 251 and the data store 252 into account.

Furthermore, according to the present embodiment, the CPU 120 transfers data to the allocation site according to the container/data allocation plan, and instructs the allocation site to deploy the program. Consequently, it is possible to construct an appropriate execution platform matching the container/data allocation plan.

The above-described embodiment of the present disclosure is the example for describing the present disclosure, and is not intended to limit the scope of the present disclosure to the embodiment. Those skilled in the art can carry out the present disclosure in various other aspects without departing from the scope of the present disclosure.

What is claimed is:

1. An allocation control apparatus that creates an allocation plan for selecting one of a plurality of sites as an allocation site, the plurality of sites each storing data and including a computer node capable of constructing an execution platform that executes a program for performing processing related to the data, and the allocation site including the execution platform and the data allocated therein, the allocation control apparatus comprising:
a memory; and a processor, wherein
the memory stores a performance model and an electric power consumption model per site, the performance model indicating a relationship between performance of the program and a resource amount of hardware necessary for realizing the performance of the program, and the electric power consumption model indicating a relationship between a resource allocation amount that is the resource amount allocated to the program, and an electric power consumption amount consumed when the program is executed, and
the processor further
receives target performance information indicating target performance for the program, calculates a necessary allocation amount and a necessary electric power consumption amount per site by using the target performance information, the performance model, and the electric power consumption model, and creates the allocation plan based on a result of the calculation, the necessary allocation amount and the necessary electric power consumption amount being the resource allocation amount and the electric power consumption amount necessary for realizing the target performance.

2. The allocation control apparatus according to claim 1, wherein
the site includes a plurality of node groups including one or more computer nodes having equal electric power efficiency,
the memory stores the performance model and the electric power consumption model per node group, and
the processor calculates the necessary allocation amount and the necessary electric power consumption amount per node group, and creates the allocation plan indicating the node group based on a result of the calculation, the node group including each of the execution platform and the data allocated therein at the allocation site in which the execution platform and the data are allocated.

3. The allocation control apparatus according to claim 1, wherein
the memory stores electric power resource information related to an electric power status at each site, and
the processor creates the allocation plan based on the result of the calculation and the electric power resource information.

4. The allocation control apparatus according to claim 2, wherein the electric power resource information includes at least one of an available renewable energy amount that is an electric power amount of renewable energy available at the site, and an intra-electric power renewable energy percentage that is a ratio of the available renewable energy amount to a total electric power amount available at the site.

5. The allocation control apparatus according to claim 3, wherein the electric power resource information includes a future prediction value of at least one of the available renewable energy amount and the intra-electric power renewable energy percentage.

6. The allocation control apparatus according to claim 1, wherein
each site includes, as the computer nodes, a first node that executes a first program as the program, and a second node that executes a second program as the program,
the memory stores a first performance model, a second performance model, and a third performance model, the first performance model being the performance model for the first program, the second performance model being the performance model for the second program, and the third performance model indicating a relationship between performance of the second program and performance of the first program necessary for realizing the performance of the second program,
the target performance information indicates target performance for the second program, and
the processor further
calculates the necessary allocation amount and the necessary electric power consumption amount for the second program by using the target performance information, the second performance model, and the electric power consumption model, and
calculates the necessary allocation amount and the necessary electric power consumption amount for the first program by using the target performance information and the first performance model, and the third performance model and the electric power consumption model.

7. The allocation control apparatus according to claim 6, wherein
the first program is a data store that manages the data, and
the second program is an application that accesses the data store and executes predetermined processing.

8. The allocation control apparatus according to claim 6, wherein
the site includes a plurality of node groups that include one or more computer nodes,
the first program is executed by a first node group, and
the second program is executed by a second node group different from the first node group.

9. The allocation control apparatus according to claim 1, wherein the processor transfers the data to the allocation site according to the allocation plan, and instructs the allocation site to deploy the program.

10. A computer system comprising:
a plurality of sites that each store data and include a computer node capable of constructing an execution platform that executes a program for performing processing related to the data; and
an allocation control apparatus that creates an allocation plan for selecting one of the plurality of sites as an allocation site in which the execution platform and the data are allocated, wherein
the allocation control apparatus includes a memory and a processor,
the memory stores a performance model and an electric power consumption model per site, the performance model indicating a relationship between performance of the program and a resource amount of hardware necessary for realizing the performance of the program, and the electric power consumption model indicating a relationship between a resource allocation amount that is the resource amount allocated to the program and an electric power consumption amount consumed when the program is executed, and
the processor further
receives target performance information indicating target performance for the program,
calculates a necessary allocation amount and a necessary electric power consumption amount per site by using the target performance information, the performance model, and the electric power consumption model, and
creates the allocation plan based on a result of the calculation, the necessary allocation amount and the necessary electric power consumption amount being the resource allocation amount and the electric power consumption amount necessary for realizing the target performance.

11. An allocation control method of an allocation control apparatus that creates an allocation plan for selecting one of a plurality of sites as an allocation site, the plurality of sites each storing data and including a computer node capable of constructing an execution platform that executes a program for performing processing related to the data, and the allocation site including the execution platform and the data allocated therein, wherein
the allocation control apparatus includes a memory and a processor,
the memory stores a performance model and an electric power consumption model per site, the performance model indicating a relationship between performance of the program and a resource amount of hardware necessary for realizing the performance of the program, and the electric power consumption model indicating a relationship between a resource allocation amount that is the resource amount allocated to the program, and an electric power consumption amount consumed when the program is executed, and
the processor further
receives target performance information indicating target performance for the program,
calculates a necessary allocation amount and a necessary electric power consumption amount per site by using the target performance information, the performance model, and the electric power consumption model, and creates the allocation plan based on a result of the calculation, the necessary allocation amount and the necessary electric power consumption amount being the resource allocation amount and the electric power consumption amount necessary for realizing the target performance.
